(19) United States
(12) Patent Application Publication
(10) Pub. No.: US 2014/0089156 A1
(43) Pub. Date: Mar. 27, 2014

(54) ADDRESSES IN FINANCIAL SYSTEMS

(71) Applicant: Cardlink Services Limited, Rhodes NSW (AU)

(72) Inventors: Richard Mark Williams, Rhodes NSW (AU); Keith Robert Goding Brown, Rhodes NSW (AU)

(73) Assignee: Cardlink Services Limited, Rhodes NSW (AU)

(21) Appl. No.: 14/094,000

(22) Filed: Dec. 2, 2013

Related U.S. Application Data
(63) Continuation of application No. PCT/AU2011/001271, filed on Sep. 30, 2011.

(30) Foreign Application Priority Data
May 31, 2011 (AU) 2011902123

(51) Int. Cl. G06Q 40/00

(52) U.S. Cl. CPC G06Q 40/02
USPC 705/35

(57) ABSTRACT

The disclosure concerns computing systems of financial institutions and computing systems that interact and support functions of financial institutions, including porting of addresses between financial institutions. When implemented as a computer, the computer enables, in communication with a network the association of a user identifier with a gaining financial institution (FI), wherein the user identifier is associated with an original FI. The computer receives from the gaining FI a request to associate the user identifier with the gaining FI. The computer then sends to the original FI the request. In response, the computer receives from the original FI a confirmation of the request and stores in computer storage a change in the association of the user identifier from the original FI to the gaining FI. As a result, a user can change accounts and FIs without having to also change the user identifier.

### CROSS-REFERENCE TO RELATED APPLICATIONS

This application is a continuation of International Application No. PCT/AU2011/001271, filed on Sep. 30, 2011, which claims the benefit of AU 2011902123, filed on May 31, 2011. The disclosures of the above applications are incorporated herein by reference.

This application is also related to the following applications, which are commonly owned with the present application and the contents of which are incorporated herein by reference in their entirety: PCT Application No. PCT/AU2011/001270, filed with the Australian Patent Office on Sep. 30, 2011, entitled “Payment Requests,” PCT Application No. PCT/AU2011/001269, filed with the Australian Patent Office on Sep. 30, 2011, entitled “Online Payment,” and PCT Application No. PCT/AU2011/001268, filed with the Australian Patent Office on Sep. 30, 2011, entitled “Transaction Document Storage.”

### FIELD

The disclosure concerns computing systems of financial institutions and computing systems that interact and support functions of financial institutions. The disclosure includes a description of methods, computer systems and software.

### BACKGROUND

The statements in this section merely provide background information related to the present disclosure and may not constitute prior art.

Before online banking, payments of household bills, such as water, gas, electricity and telephone, were primarily made over the counter at the biller's offices, over the counter at the biller's financial institution (e.g. bank) or by cheque through the postal mail.

The launch of online payment systems, such as BPAY in Australia, began the era of customer convenience and choice in payment channels to pay bills. The BPAY payment system provides customers a simple electronic method of paying bills, irrespective of the biller's or payer's bank financial instution (FI). BPAY offers billers (i.e. businesses) a reliable, secure, electronic channel for receiving payments from customers.

Billers display the BPAY logo on their bills along with their biller code (i.e. biller identifier) and the customer reference number (CRN) that refers to the transaction. Payment transactions are initiated by payers from either telephone or internet banking platforms. The payer does not need to know the biller's FI as the BPAY payment system uses the biller code to route payment instruction to the biller's FI.

The CRN includes a ‘check digit’, this is a number that is calculated from the reference number using a check digit algorithm. The purpose of the check digit is to reduce the possibility of the payer accidentally transposing the numbers in the CRN when entering them into their banking interface. Thus if a payer enters a CRN with an invalid check digit the entry is rejected by the check digit algorithm. This approach leads to a higher level of accuracy when payers enter CRNs.

A BPAY payment transaction offers billers an electronic transaction with cleared funds that are not subject to chargebacks or dishonours.

The payer's FI immediately allocates the funds to the transaction. The transaction is batched by the payer's FI and sent to BPAY for inclusion in settlement processing for that night. Settlement between FIs is made the next business banking morning.

As BPAY payments are ‘pushed’ by the payer to the biller through the Australian banking network they are not processed through third party networks such as the international card scheme networks that attract usage fees.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

### SUMMARY

In a first aspect there is provided a computer implemented method for associating a user identifier with a gaining financial institution (FI), wherein the user identifier is associated with an original FI, the method comprising:
(a) receiving from the gaining FI a request to associate the user identifier with the gaining FI;
(b) sending to the original FI the request;
(c) receiving from the original FI a confirmation of the request; and
(d) storing in computer storage a change in the association of the user identifier from the original FI to the gaining FI.

It is an advantage that the user identifier is portable between accounts of different FIs. As a result, a user can change accounts and FIs without having to also change the user identifier. Since the user identifier is used to primarily send and receive money, the user does not need to change payment arrangements when changing bank accounts.

It is a further advantage that the associations between user identifiers and FIs are maintained by a central management financial service (CMFS), yet a user does not need to interact with the CFMS in order to effect the change.

The user experience in changing FIs is made less complicated by this method. This encourages users to change their FIs resulting in more competition, and in turn falling prices and better quality of banking services and innovation.

The method may comprise the further step of sending to the gaining FI confirmation of the association of the user identifier with the gaining FI.

The method may further comprise the step of determining the original FI that the request should be sent to based on the user identifier as included in the request.

Step (a) of the method may comprise receiving a verification code.

Step (a) of the method may comprise receiving identifying information.

Step (a) of the method may comprise the additional step of validating the request based on the verification code and/or the identifying information.

It is an advantage of the invention that a user provides a verification code that is only known to the user and the CFMS. As a result, the method is secured against third parties trying to initiate a port without the authorisation from the user.

After step (b) the method may further comprise the steps of: receiving from the gaining FI an authorisation code; and sending the authorisation code to the original FI.

It is an advantage that the use of an authorisation code reduces the risk of fraudulent transfer of a user identifier to a gaining FI due to malicious intent. The code is issued by the original FI to the user and the user provides the code to the gaining FI.

It is a further advantage of the invention that the original FI provides to the user an authorisation code that is only valid for one particular request or particular time frame providing an extra measure of security.

Step (a) of the method may comprise receiving attributes associated with the user identifier. It is an advantage of the invention that a separate entity, such as a portal, pre-arranges the approval of the port request. The results of this approval process may be included into the attributes associated with the user identifier. Although the original FI still confirms the request, the actual approval process is orchestrated by the portal.

After at least step (b), the method further comprise the steps of:

receiving first data associated with the user identifier from the original FI; and

sending second data based on the first data to the gaining FI.

The data associated with the user identifier may be financial data such as transaction history. The first data may be an address book. The first and second data may be different, for example the second data may include a subset of the first data. It is an advantage that the user has the data available even after the user changes to a different FI. As a result, the change is seamless for the user and the user can benefit from all the advantages that the gaining FI offers without loosing the financial data that may be of great value to the user.

In a second aspect there is provided software, that is, computer readable instructions recorded on computer readable media, that when executed by a computer causes the computer to perform the method described directly above.

In a third aspect there is provided a computer system for associating a user identifier with a gaining FI, wherein the user identifier is associated with an original FI, the system comprising:

computer storage to store an association of the user identifier with the original FI;

one or more communications ports; and

one or more processors to operate the communications port to receive from the gaining FI a request to associate the user identifier with the gaining FI, send to the original FI the request and receive from the original FI a confirmation of the request, and cause a change in the association of the user identifier from the original FI to the gaining FI to be stored in computer storage.

Optional features of the first aspect are also optional features of the second and third aspect.

In a fourth aspect there is provided a computer implemented method for disassociating a user identifier from an original FI, the method comprising:

(a) receiving a request for confirmation to disassociate the user identifier from the original financial institution;

(b) determining authorisation to disassociate the user identifier from the original FI; and

(c) sending confirmation to disassociate the user identifier.

Step (a) may be received from a portal or a CFMS.

The method may further comprise the step of storing in computer storage a change in the disassociation of the user identifier from the original FI.

Step (b) may further comprise:

sending to the user associated with the user identified a first authorisation code;

receiving from a CMFS a second authorisation code;

determining whether the first and second authorisation code matches and if so, only then performing step (c).

Alternatively step (b) may further comprise:

determining whether there is approval for the request recorded in computer storage and if so, only then performing step (c).

At least after step (b), the method may further comprise sending data associated with the user identifier.

In a fifth aspect there is provided software, that is, computer readable instructions stored on computer readable media, that when executed by a computer causes the computer to perform the method described directly above.

In a sixth aspect there is provided a computer system for disassociating a user identifier from an original FI, the system comprising:

one or more communications ports; and

one or more processors to operate the communications port to receive a request for confirmation to disassociate the user identifier from the original financial institution, to determine authorisation to disassociate the user identifier from the original FI, and to operate the communications port to send confirmation to disassociate the user identifier.

The optional features of the fourth aspect are also optional features of the fifth and sixth aspect.

In a seventh aspect there is provided a computer system for controlling the process of associating a user identifier with a gaining financial institution (FI), the computer system comprising:

a persistence layer to store a status for the payment and user data including a user identifier and associated original financial institution (FI);

a communication and mediation layer to receive an output message from a service layer, to send the output message to a recipient, to receive an input message from a sender, to validate the input message and to send the input message to the service layer; and

the service layer to receive the input message from the communication and mediation layer,

where the input message includes a port request to associate the user identifier with a gaining FI, to determine a user identifier based on the payment request, to determine an original FI based on the user identifier and the user data in the persistence layer, to create the output message having the original FI as recipient and including the port request, that causes the original FI to send to the user an authorisation code that is associated with the port request, to send the output message to the communication and mediation layer and to set the status in the persistence layer to waiting for authorisation request,

where the status is waiting for authorisation request and the input message includes an authorisation request associated with the port request and having the authorisation code as provided by the user to the gaining FI, to determine the original FI, to create the output message having the original FI as recipient and including the authorisation request, that causes the original FI to verify the authorisation code, to send the output message to the communication and mediation layer and to set the status in the persistence layer to waiting for authorisation confirmation, and

where the status is waiting for authorisation confirmation and the input message includes an authorisation confirmation, to determine the gaining FI, to create the output message having the gaining FI as recipient and including the authorisation confirmation, to send the output message to the communication and mediation layer, and to store in computer storage a change in the association of the user identifier from the original FI to the gaining FI.

### DRAWINGS

FIG. 1 illustrates a bill payment system of a first example;

FIG. 2 schematically illustrates the method of the first example;

FIG. 3 illustrates a bill payment system of a second example;

FIG. 4 schematically illustrates the method of the second example;

FIG. 5 illustrates a computer implemented method for associating a user identifier with a gaining FI as performed by a central financial management system (CFMS);

FIG. 6 schematically shows the applications layers of the CFMS;

FIG. 7 schematically shows the state transitions of a state machine of the CFMS; and

FIG. 8 illustrates data on a data store if the CFMS.

### DETAILED DESCRIPTION

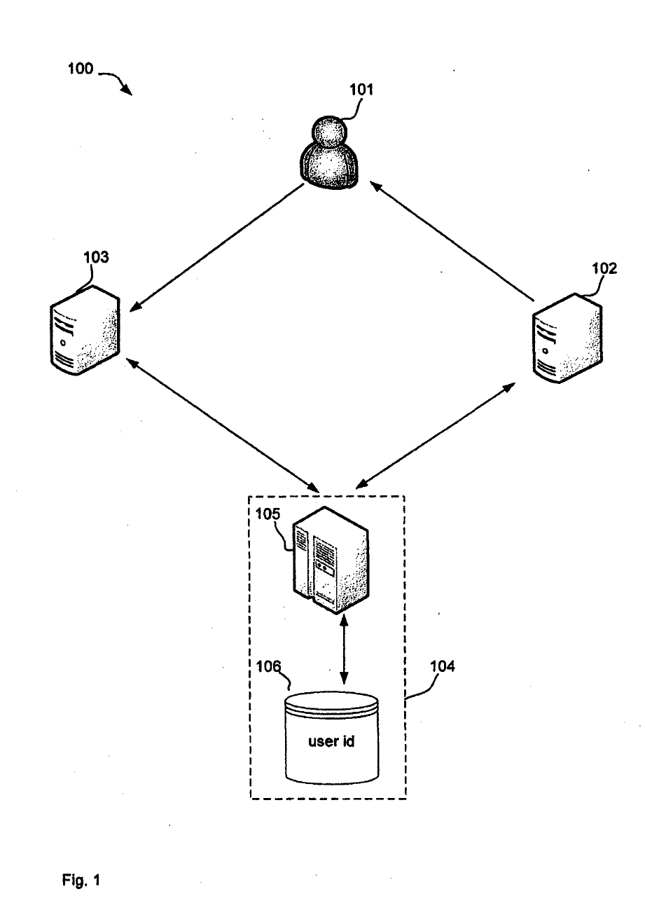

FIG. 1 illustrates a financial grade information system, such as a bill payment system 100 comprising a user 101 who has one or more accounts with an original FI 102 that is associated with their user identifier. The user 101 wishes to open a new account with a gaining FI 103 and use the same user identifier with this new account. The original FI 102 and the gaining FI 103 are connected to a central financial management system (CFMS) 104 via one or more communication I/O portals using the internet or other wide area networks (WANs). As is described further below, in this example messages sent to or from the I/O ports are comprised of data wrapped in XML.

Each message associated with the same transaction includes a unique transaction identifier allowing the different parties to associate subsequent messages received and sent relating to the particular transaction. For example, if the transaction is the porting of a user identifier, then a port request and confirmation include the same transaction identifier.

Throughout this document, the word “transaction” is not limited to actions that result in transfer of funds, such as payments. Transactions comprise multiple steps of communication between the different parties involved. In one example, the transaction is a port of the user identifier from the original FI 102 to the gaining FI 103.

The user 101 may be an individual, such as a natural person, or non-individual, such as a company.

The CFMS 104 comprises one or more processors, that is a computer processing system, such as a server 105, and computer storage 106, such as non-volatile memory. The computer storage 106 of CFMS 104 stores for each user the following information:

user data for the user 101, that is a unique a user identifier

the original FI 102 associated with the user identifier

display details, such as the name published with the user identifier, the customer type (e.g. individual, business, government), official identification numbers (e.g. ABN, ACN) allowable usage information (e.g. accept real time notifications? payment requests? online transactions?) blocked list information, that is other user identifiers that are blocked from sending messages to this user identifier limit information, minimum and maximum values that can be received by the user identifier transaction history, that is information of all transactions performed using the user identifier as stored by the CFMS 104 as they occurred other information associated with the user identifier, such as auto pay rules and scheduled payment information.

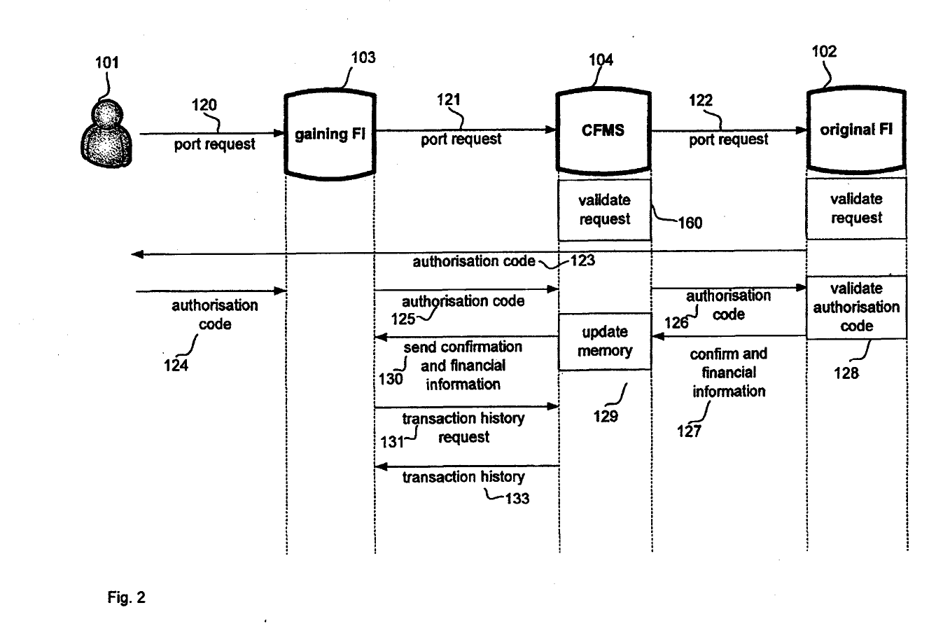

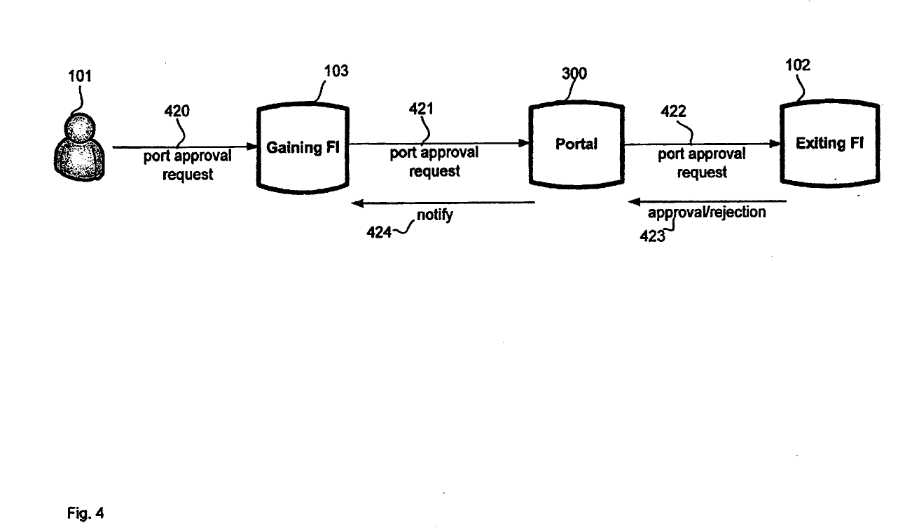

The CFMS 105 also has installed software that the sever executes to perform the method described here, which includes querying and updating the computer storage 107 and generating and sending messages to the original FI 102 and gaining FI 103 as appropriate. This is described in more detail further below in relation to FIGS. 2 and 4.

The original FI 101 also has computer storage (not shown) that stores for each user identifier:

associated account information, such as account identification information and current balance transaction information, including received payments.

The original FI 101 also has installed software that a processor executes to perform the method described here.

The gaining FI 103 also has computer storage (not shown) that stores for each user identifier:

associated account information, such as account identification information and current balance

transaction information, including received payments

The gaining FI 103 also has installed software that a processor executes to perform the method as described here.

For simplicity only one of each entity 101, 102 and 103 is shown in FIG. 1, however it should be understood that in practice multiples of each entity participate in this system 100.

A person skilled in the art will readily appreciate the different ways the online banking facilities of FIs 102 and 103 can be accessed by a user 101 using a computer device, such as a personal computer or smart phone. Examples include through an internet browser, such as Microsoft Internet Explorer, Mozilla Firefox or Google Chrome. Alternatively, the receiver uses a smart phone in connection with a dedicated software application (software app) or smart phone application.

In this example, the port between the original FI 102 and the gaining FI 103 is facilitated by the CFMS 104 such that the user identifier is associated with the gaining FI 103 a short time after the port request was sent, such as 5 seconds. That is the port is performed in real-time.

When in use, user 101 may advise a second user (not shown) of their user identifier. The second user may then log into an internet banking website of the second user's bank (not shown) and transfer money to the user 101 utilising the user identifier. The second user's bank then queries the CFMS 104 to determine which bank this particular user identifier is associated with. Using this information, the transfer of funds from the second user to the first user 101 can be completed. The CFMS 104 receives and stores details of the transaction in the transaction history. As a result if the user 101 changes banks from original bank 102 to the gaining FI 103 and conveniently wishes to retain use of their user identifier, the data in the computer storage 106 needs to be updated to reflect the association of the user 101 with the gaining FI 103. After the porting is complete the gaining FI 103 may download the transaction history from the CFMS 104 and display this local copy to the user 101. This increases the speed of the online banking website while reducing the frequency of traffic between the gaining FI 103 and the CFMS 104.

The method for changing the association of the user identifier with the FI will now be described with reference to FIG. 2.

To initiate this change, the user 101 initiates 120 a port request for this change through the gaining FI 103, such as using an internet banking website. In order to log into the internet banking website, the user 101 provides the user identifier and an associated verification code, such as a password. If the user 101 does not have a verification code the user 101 can follow a manual process of setting up a verification code for porting, (e.g.; phone the original FI to establish the verification code). The gaining FI 103 is the bank the user wants to have their user identifier associated with in future. The port request includes the user identifier and the associated verification code that the user 101 has entered.

The gaining FI 103 sends 121 a port request to the CFMS 104 which contains the user identifier, the verification code and a transaction identifier.

In one example the gaining FI 103 includes the user's date of birth and the first and last name of the user into the request to the CFMS 105. This information is sent from the gaining FI 103 to the original FI 102 (via the CFMS) to ensure it is the same person the user identifier is ported to.

In another example the gaining FI 103 also includes the user's display name, ABN and ACN.

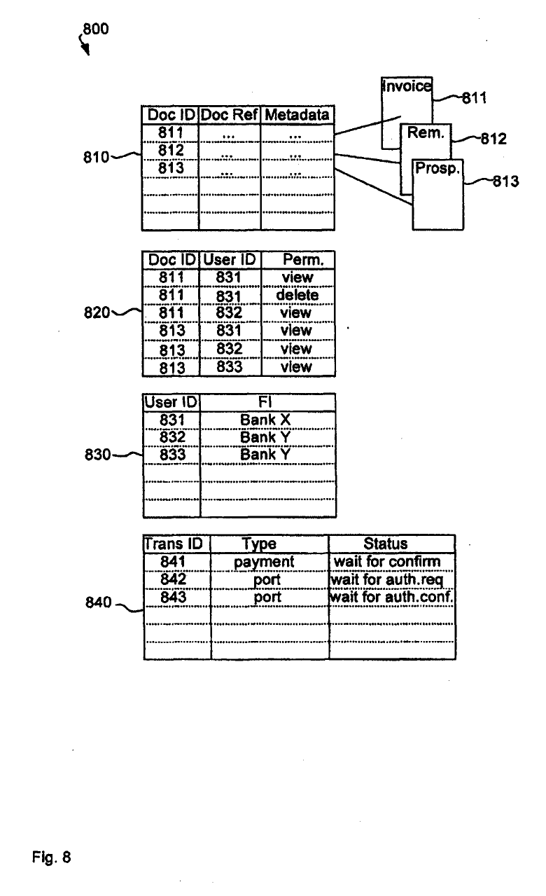

The CFMS 104 validates 160 the request and determines the original FI 102. That is, it identifies in the computer storage 106 the FI 102 currently associated with the user identifier. The step of determining will be described with reference to FIG. 8 below. The CFMS 104 validates the allowable usage on porting and checks that self porting is allowed to ensure the original FI 102 (at the customer's request) has not set a self port lock.

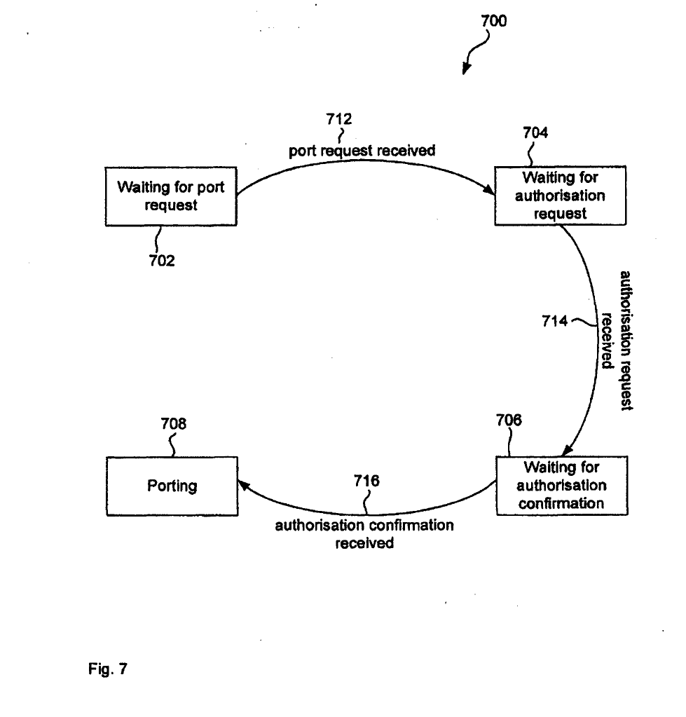

A state machine is created that is associated with the transaction identifier. The state of the state machine is set to waiting for authorisation request from the gaining FI 103 as will be described with reference to FIG. 7 below.

The CFMS 105 then sends 122 the port request to the original FI 102. The actual content of the request may differ from the port request as received from the gaining FI 103. That is, the port request may include further information than what was in the request 121 and/or in some alternatives information could be removed. For example, the port request 121 may include an identifier of the gaining FI that is not sent to the original FI in the request 122. Alternatively, the original FI identifier could be added to the message. The same principals applies to all messages sent by the CFMS 105 that are based on an earlier received message.

The original FI 102 validates the received request by comparing the user identifier and verification code with that stored by the original FI 102. Authorisation of the port request is now performed to help ensure that the request did in fact come from the user 101. The original FI 102 provides 123 the user 101 with a authorisation code for this change request. This may be achieved by the user 101 logging into a banking website of the original FI 102 and the authorisation code being displayed on the banking website. Alternatively, the original FI 102 may send a letter, an email or an SMS to the user 101 containing the authorisation code. In any case, it must be ensured that an authorisation code can only be obtained by the authenticated holder of the account with the original FI 102.

Once the user has obtained the authorisation code, the user provides 124 the authorisation code to the gaining FI 103, such as entering it into the online banking website of the gaining FI 103. Since the user can provide the authorisation straight to the gaining FI 103, the gaining FI 103 need not send any communications to the original FI 102 to effect this change, making it convenient for the user 101. For example, if the authorisation code 123 is provided to the user 101 via SMS the change can be applied directly and without the user 101 leaving the internet banking website of the gaining FI.

The gaining FI 103 sends 125 an authorisation request including the authorisation code to the CFMS 104. The CFMS 104 in turn, sends 126 the authorisation request to the original FI 102 to enquire whether the authorisation code is valid. In order to monitor the responsiveness of the original FI 102, the CFMS 104 starts a timer that alerts the CFMS 104 if a response from the original FI 102 has not been received within a predefined maximum response time. To validate 128 the received code the original FI 102 compares the received authorisation code to the authorisation code originally sent to the user 101 in step 123. If the two codes are identical, the original FI 102 sends 127 an authorisation confirmation back to the CFMS 104. The original FI 102 also records in the computer storage (not shown) associated with its system 102 a disassociation between the user identifier and the financial account previously associated to the user identifier. For example in a database of the original FI 102 removing the active links between the user identifier and the financial account identifier.

It is noted here that the original FI 102 has already authenticated the user 101 by checking the verification code when the original FI 102 received the port request. Therefore, the CFMS 105 only needs to check whether the authorisation confirmation originated from the original FI 102. There is no need for the CFMS 105 to authenticate the user 101 again. In this example, checking whether the payment request originated from the original FI 102 involves using a public key of the original FI 102 to check a signature that was created using a private key of the original FI 102 and attached to the authorisation confirmation by the original FI 102.

Now that port authorisation is complete port execution is performed. The original FI 102 now sends 127 information associated with the user identifier to the CFMS 104. In one example, the information includes only address book data, that is identifying information of other user identifiers or accounts that the user 101 has stored information about at the original FI 104. Typically, the address book is compiled over time by the user 101 when transacting using their user identifier at the original FI 102. Since the user 101 is able to bring with them their address book to the gaining FI 103 this has the advantage of making it easier for a person to change FIs generally. In other examples, the information associated with the user identifier could include financial information such as transactions history that was based on the user identifier or non-value items, such as medical or recordkeeping documents stored by the original FI 102.

Having received confirmation that the change of FIs is legitimate, the CFMS 104 updates 129 the computer storage 106 to store the change in that the user identifier is now associated with the gaining FI 103. The computer storage 106 is also updated to reflect the contents of the received address book. The CFMS 104 then sends 130 a confirmation of the change of FIs to the gaining FI 103.

The CFMS 104 stores the transaction data, that is the data related to the port, in the data store such that a history of all transactions including ports of the user identifier is available. The gaining FI 104 can download the transaction history from the CFMS 104 and make the history available to the user 101 without generating additional regular traffic for the CFMS 105.

The CFMS 104 can also provide information associated with the user identifier stored on the computer storage 106. In this example the gaining FI 103 also requests 131 a copy of the transaction history stored by the CFMS 104 in the computer storage 106. In an alternative embodiment the request could originate from the user 101. The CFMS 104 generates the transaction history and sends 133 it to the gaining FI 103. The gaining FI 103 incorporates this transaction history into the transaction history data associated with the account that the user identifier is now associated with. Advantageously, the user 101 can also access their transaction history of their user identifier, such as when logged into internet banking at the gaining FI 103, even though those transactions were made on the account held with the original FI 102.

If now the second user transfers money with the user identifier as the recipient as described above, the CFMS 104 retrieves the association to the gaining FI 103 and the money is transferred to the new account of the user 101.

Since the change of FIs does not require a change of the user identifier, the user 101 advantageously keeps the user identifier for a lifetime. As a result, the user 101 can take advantage of attractive offers from competing FIs without having to change their user identifier, lose their information associated with the transaction history.

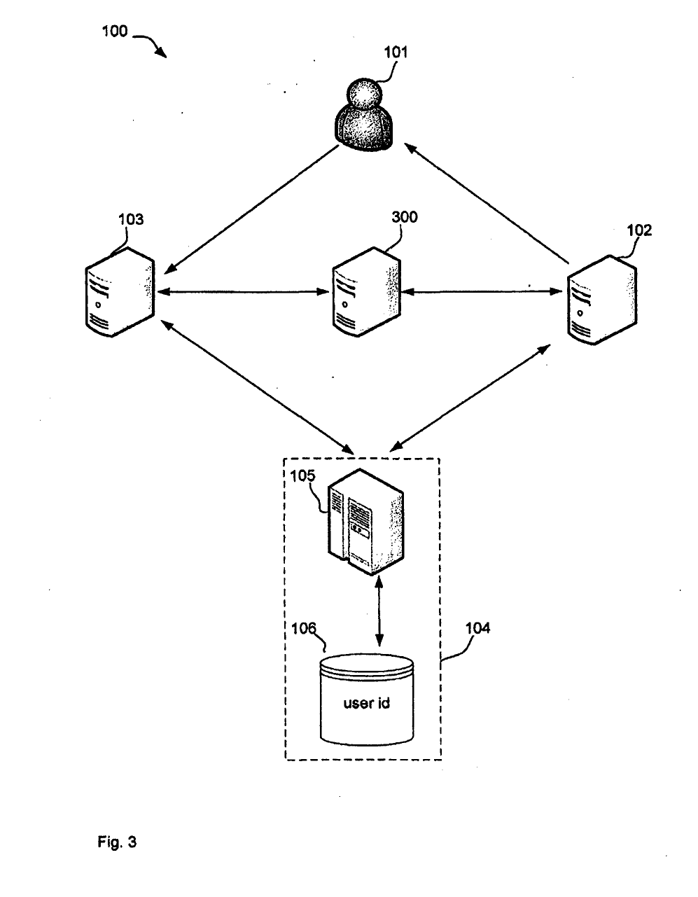

FIG. 3 and FIG. 4 illustrates a second example of a financial grade information system 200. Similar to the example explained with reference to FIG. 1 and FIG. 2, the system 200 comprises a user 101, an original FI 102, a gaining FI 103 and a CFMS 104.

In contrast to FIG. 1, this system 200 further comprises a portal 300 that is able to communicate with the original FI 102 and the gaining FI 103 again using a communications portal. In this example, the user 101 is not required to handle an authorisation code. Instead, the user 101 initiates a port request 420 to the gaining FI 103. The gaining FI 103 creates 421 a port approval request via the portal 207 including all authentication documentation, such as evidence of company's registration, user's authority to execute the port, user identification or any other documentation deemed appropriate by the FIs. The portal 207 sends 422 a port approval request notification including associated documentation to the original FI 102. The original FI 102 determines whether the request is valid by comparing the authentication documentation received with the request to the original FI's own records. The port approval request is then approved or rejected and the original FI 102 sends the appropriate response 423. Record of the approval is stored by the original FI for future reference. The portal 300 then notifies 424 the gaining FI 103 of the decision of the original FI 102. The portal 300 also sends a notification of the decision to the CFMS 104 (not shown).

The next steps include the CFMS 104 and are similar to the steps explained with reference to FIG. 2. The gaining FI 103 sends 121 to the CFMS 104 a port request that includes the user identifier. The CFMS 104 validates 160 the request to ensure a port approval request for that user identifier has previously been approved and sends 122 the request to the original FI 102. The original FI 102 confirms the approval of the port request and provides data associated with the user identifier to the CFMS 104 (similar to 128 and 127 but without reference to an authorisation code). The financial data comprises all, some or none of the financial information available at the original FI 102.

The CFMS 104 then associates 129 the user identifier with the gaining FI 103 and updates the user identifier with the financial data. The CFMS 104 notifies 230 the gaining FI 103 of the outcome of the port request and includes a copy of the financial data, such as the address book. The gaining FI then notifies 134 the user that the port has taken effect.

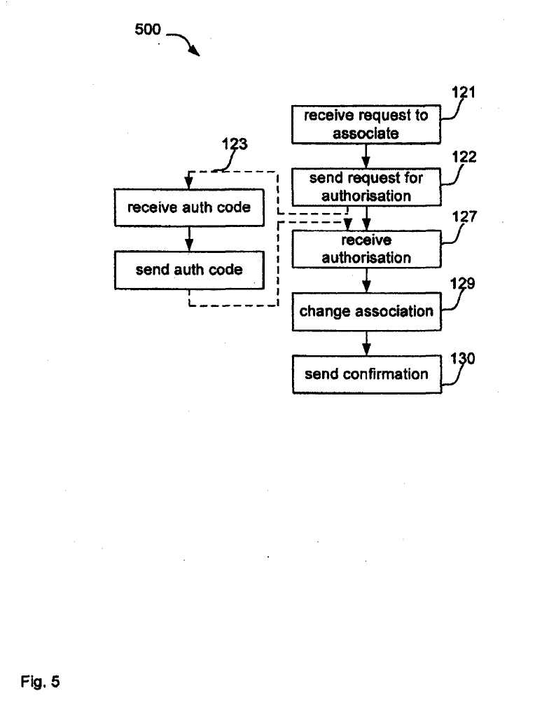

In the two examples explained with reference to FIGS. 1 and 3 the CFMS 104 performs similar steps in order to orchestrate the port of the user identifier from the original FI 102 to the gaining FI 103. The difference is that in FIG. 3 the portal 207 performs additional preliminary steps for port approval before the actual port takes place between the two FIs 102 and 103 and the CFMS 105. The method performed by the CFMS 104 is shown in the flow chart of FIG. 5.

It should be understood that there are many variations to these examples. For example transaction history is stored with the CFMS 104 and address book information is stored by the original FI 102. In other examples, information associated with a user identifier can be shared and/or duplicated in a different way than described here. For example:

all the information can be centrally stored with the CFMS 104,

stored with a FI and shared in case the user changes to a different FI, or

stored with a FI and not shared in case the user changes to a different FI.

In this example, the original FI 102 also stores associated with the user identifier further financial information such as:

autopay rules, such as instructions to automatically pay in response to payment requests sent from particular entities or user identifiers

notification preferences, such as a preference to be notified by SMS or email on receipt of a payment to the user identifier

limits, such as limit to the value and number of transactions that can be made using the user identifier.

In other examples some or all of this information can be provided to the CFMS 104. At the same time some or all of the information stored by the CMS 104 can be stored with the FIs.

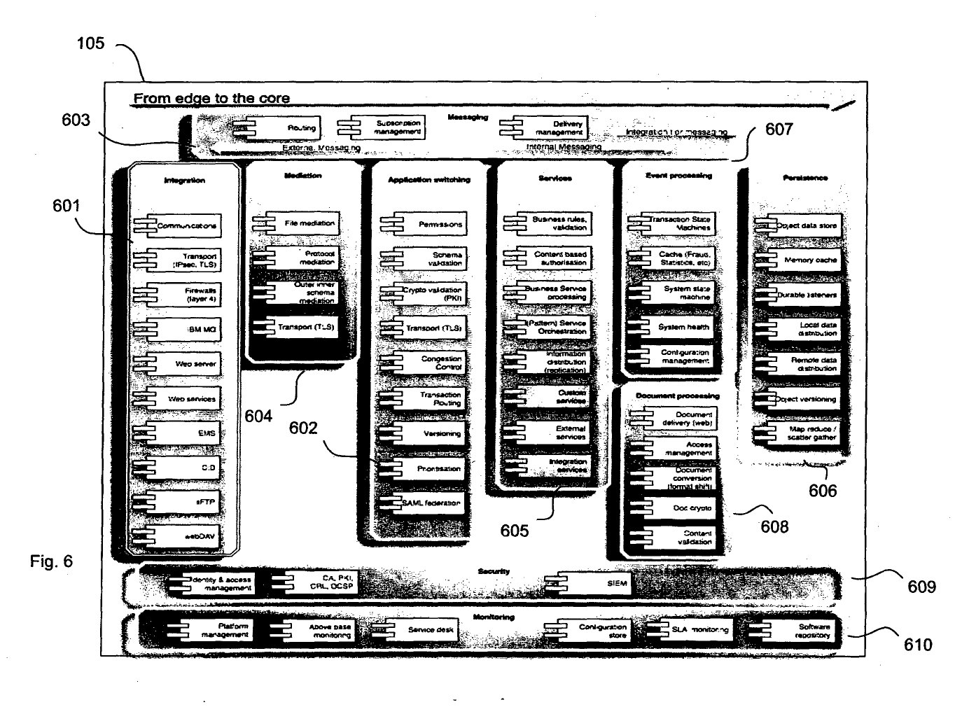

FIG. 6 illustrates the CFMS 104 in more detail in form of an application layer decomposition by functionality. One of the layers comprised by the CFMS 104 is an integration layer 601. This layer is the application gateway into the CFMS 104. In the OSI stack this translates into all communication from layers 4 to 7. This includes name services (DNS), including proximity and topology based DNS resolution of system resources for the clients. This is achieved by the global traffic manager (GTM) functionality of the F5 Big-IP platform. Resource based load balancing is implemented within the CFMS 104, where incoming connection requests are directed to the application host. This redirection can be based on application specific service matrix, including, sticky, round-robin or least count etc.

This layer allows to better manage the resources as well as, in event of an application node failure, it also allows to seamlessly re-direct the request to surviving application nodes. The integration layer 601 also comprises IBM MQ Services, including Queue management, routing, recovery, redundancy of traffic using IBM MQ application.

The CFMS 104 hosts its own queue manager framework. The queue manager provides the low level technical ack, nack and time-outs functionality. Web services, for synchronous communication are also integrated into the integration layer 601. Web services are screened for security issues using the Application Security Manager (ASM) from the F5 Big-IP product modules. The integration layer 601 further comprises web servers for all web requests for document retrieval as well as file upload, download for bulk file integration using Web-based Distributed Authoring and Versioning (WebDAV) method. Connect:Direct and Secure Shell File Transfer Protocol (sFTP) is used for the file transfers. All file transfers are managed from network file shares. The file mediation services in the mediation layer make use of the file system events to initiate the file processing. This is more efficient then polling a file system.

CFMS 104 further comprises an application switching layer 602 performing the functionalities of content based routing, message validation services and Security Assertion Markup Language (SAML) federation.

The application switching layer 602 routes messages based on “affinity” where functions are stateful, such as complex event processing functions. For example, a transaction involving a 3-party pattern should be processed at a single service tier. However, messages from participants may be delivered to via any data centres of the CFMS 104 or components within the data centres.

In the distributed CFMS 104 a message related to a transaction may be received by a location or stack not processing the specific transaction. The application switching layer 602 will identify the correct processing stack and route the message over. The routes of the messages are based on version of the schema used.

The application switching layer 602 prioritises messages based on importance of a message at a business layer, such as a block address request as part of fraud management.

The application switching layer 602 provides message validation services for confidentiality and assurance (decryption, encryption, signing, signature validation), access control (permissions and roles), technical validations (e.g., XML wellformedness) and business validations (higher level validations, if any) and SAML federation. This is used for processing document retrieval requests received by the CFMS 104. It involves validation of the assertion, invoking request to the back-end services and coordination of the response including additional SAML assertions to the caller.

CFMS 104 also comprises a messaging layer 603. The messaging layer 603 is a distributed high speed messaging tier that allows for very low latency and asynchronous message exchange in a reliable fashion. In line with the N+1 design principles, the messaging grid will autonomously recover from component failures. Each messaging server has a warm standby which allows for near instantaneous and stateful recovery with zero data loss. The messaging functionality includes queue, topics and subject based communication as well as integration with presence—for example based on Extensible Messaging and Presence Protocol (XMPP) or Remote Authentication Dial In User Service (RADIUS) events for end-point detection for transmission. The messaging functionality also includes message routing within and across the stacks and message level priority management and congestion control.

Three distinct messaging layers operate across the CFMS 104: external messaging, internal messaging and integration messaging. These layers are based on three distinct security zones. There is an additional messaging service used by the monitoring services.

Each messaging layer is to support the application services hosted at that tier and typically align with the security zones. There is no message routing crossing the security zone. All messages crossing the security zones will always go through a mediation layer 604.

Mediation layer 604 comprises message transformation services to transform messages from external to internal or vice-versa or from external to external.

The mediation layer 604 also comprises orchestration functionality for integration with the core of the CFMS 104, detection of duplicates, stripping of documents and integration of document processing, bulk file iteration and response collator integration.

An internal facing mediation tier provides integration with settlement engine, which includes real time messaging integration for continuous streaming of information as the transactions take place and once a day files processing such as updates to Biller Master File (BMF). The internal facing mediation tier also provides integration with an Ops Portal that also includes file transport functionality where members can submit instructions by Bulk file and collect responses to the bulk files submitted by them. The internal facing mediation tier further provides billing and business intelligence.

CFMS 104 further comprises a service layer 605. This layer is where bulk of service functions are orchestrated based on the needs of various patterns. The services also include functionality for error correction, capturing errors and compensating actions. Some of the service functions will be bespoke to meet specific requirements. These include creation of the user identifier, transaction reference, universally unique identifier (UUID) generation with site affinities, etc. The services are hosted within the enterprise service bus (ESB) and communicate using messaging layer. The service layer is stateless while orchestrations are stateful. Complex event processing systems are used to manage and maintain the states as well as the state transformation machines.

One of the key functions hosted out of the services layer is integration with a persistence layer 606. The persistence 606 is provided by a Data Grid. The data access is abstracted at the service bus. The data access functions facilitate replication of data across all data grids where replication is addressed as part of the business transaction. This allows provisioning of additional system capacity in a near linear scalable fashion. Additional capacity can also be provisioned on demand. This design approach also allows for quick re-purposing of capacity for other functions. For example, the document rendering/processing capacity could be increased during end of the financial year period for capacity and service level management.

The CFMS 104 will have several service busses to meet requirements in different security zones:

a) External Demilitarized Zone (DMZ), to allow for functions such as duplicate transaction detection, enforcement of allowable usage types, and address allocation maps.

b) Document processing, to allow for all orchestration to process, store and retrieve documents. There are a few integrations with bespoke code, and appliances.

c) Internal, will include all other technical services. The internal services includes where orchestrations span stacks and/or sites. Orchestration across stacks, sites may be used where replication is part of business transaction.

Another layer within the CFMS 104 is an events processing layer 607 which is the control tier of the CFMS 104 applications. One of the core functions that this application layer provides is managing and maintaining transaction states. This is achieved by state-transition-machines. State machines are defined for each transaction flows. It is the state machine that orchestrates the transactions provides event correlation with the other components of the CFMS 104 such as document processing provides the time-based event processing for TTRs.

The state machines are typically initialised by the first message/event in a transaction or instruction received by the CFMS 104. Subsequent processing and functions performed on the transaction result in events being generated. These events are relayed back to the state machine and based on the event it undergoes state changes. Once a transaction is complete and committed, the state machine is destroyed.

The event processing engine is also used for real-time collection of intelligence, such as fraud and statistical data generation for the user identifier. These statistics are kept hot and up to date as transactions are processed.

As mentioned above, the persistence is achieved by a data grid which is coordinated by a persistence layer 606. Geographic reach of the data grid together with a data grid provide internal replication in real-time to both the intra and inter grid members. The data grid will be built to ensure a deterministic N+1 or better redundancy. This will allow the data grid to autonomously recover from component failures, sacrificing neither the data quality nor the data reliability. Persistence applies to entities that need to be persisted and entities that need to be accessible for all of above to work.

The CFMS 104 applies a shared nothing architecture. In order to achieve higher resilience and availability, non-blocking and near linear performance scalability, the data grid nodes will make use of direct attached storage. This also removes any single points of contention and single points of failure from the persistence tiers. This also reduces complexity in design by removing the need for Storage Area Network (SAN).

The data within the CFMS 104 needs to be consistent across all data centres. This requires data to be distributed as the data changes as part of various transaction flows. Within a transaction flows there are pre-defined commit points where recoverability and consistency needs to be ensured. For example, for a transaction, at some key points the system needs to ensure that data is also at the other data centre. These two points need to be synchronous. However, all other replication and data distribution within this transaction flow can be asynchronous.

The CFMS 104 further comprises a document processing layer 608. The CFMS 104 will be processing documents included as attachments, including non value instructions. This will be invoked as part of 3, 4 party patterns where a document or uniform resource locator (URL) or uniform resource identifier (URI) is attached to the message.

The CFMS 104 further comprises a security layer 609. The security layer 608 performs identity and access management employing a multi-factor authentication subsystem, a Certification Authority (CA) component and a role based access control subsystem. The multi-factor authentication subsystem provides strong authentication and integration with the federation components for admin and operator authentication and access control. The CA component provides X.509 certificate provisioning and management facility. The CA also provides a Certificate Revocation List (CRL) and Online Certificate Status Protocol (OCSP) services to ascertain validity/currency of X.509 certificates as part of the mutual authentication flow. The role based access control sub system will link identity to entity and their roles and access rights.

The security layer 608 also performs Security Incident and Events Management (SIEM), exception handling and management. To perform these tasks the security layer 608 employs logging components and correlation engines. The logging components provide a centralised facility to log all the messages and events, including network devices, security devices and services. This information can be used to debug and trace events and correlations between various events. The correlation engines are used to identify related events, patterns for security and other compliance escalations.

The security layer 609 also performs operational monitoring and maintenance, such as vulnerability assessment including intrusion detection and internal and external vulnerability scanning.

Further, the CFMS 104 comprises a monitoring layer 610. As part of the handover to Technology Operations and production readiness five scenarios will be tested to meet the integrity and recoverability targets:

deep polling and synthetic transactions;

split-brain;

recovery;

cold boot; and

application maintenance and upgrades.

Split-brain can happen if one data centre hosting the CFMS 104 looses visibility to the other data centre and as a result islands itself. This may force each data centre to autonomously infer that it is the last surviving node and the other node is down. Automatic detection of split-brain using third party quorum, majority detection which would result in one of the two data centres to be taken down as active to pending consistency status.

Following steps are included in the technical solution to reduce likelihood of a split-brain:

use of two Telco carriers with no shared elements between the carriers.

each link will be provided with redundant path and redundant presentation. Use of technologies such as fully protected Synchronous Digital Hierarchy (SDH) ring allows recovery to alternate path in milliseconds.

ability to achieve quorum via links to networks for the transmission of clearing and settlement transactions such as the Community of Interest Network (COIN) of the Australian Payments Clearing Association (APCA), Internet and out of band (OOB) management. Links will allow detection of the loss of inter data centre carriage.

Recovery of a data centre from a planned or unplanned outage needs to automatically trigger background data sync and only bring a data centre/stack online once their state is consistent with rest of the CFMS 104. Recovery comprises the key features of identifying the need for recovery, isolating the data sets pending recovery/re-sync and testing for completeness and correctness of recovery/sync.

A cold boot occurs in an extreme case, if the CFMS 104 and all its data centres are taken offline. Automation will be in place for a cold boot scenario.

The layering of applications within the CFMS 104 in this form allows for seamless horizontal and vertical scalability by bolstering components at each layer as required. This specific design also assists in managing performance and service levels and helps in limiting the impact of changes which will be required during the lifecycle of the CFMS. As a result, the overall maintainability, scalability and in turn availability of the CFMS is improved. For example, introduction of messaging based on the Advanced Message Queuing Protocol (AMQP) will only require additions to the integration layer 601 and mediation layer 604.

In one example, the request for changing the FI 121 in FIG. 1, arrives at the CFMS 104 as an encrypted Extensible Markup Language (XML) message. The message is received by a web service of the integration layer 601. In other examples the message is received via an encrypted channel, such as IPsec, between the gaining FI 103 and the CFMS 104. The integration layer 601 sends a transport level acknowledgment to the gaining FI 103.

The message is handed over to the mediation layer 604, which converts the message from the outside schema to an inner schema. The mediation layer 604 converts messages from various different protocols into the same inner schema. Now that the message is in a suitable format for internal layers, it is forwarded to the application switching layer 602. The application switching layer 206 validates the encryption of the message including the validity of the key and routes the message to the appropriate module of the services layer 605.

In a different example, the integration layer, mediation layer and application switching layer are combined into a communication and mediation layer. This communication and mediation layer may act as an input and then receives an input message from an external sender, validates the input message and sends the input message to the internal service layer 605. This communication and mediation layer may also act as an output and receive an output message from the internal service layer 605 and send the output message to an external receiver.

The services layer 605 orchestrates the communication pattern that is necessary for associating the user identifier with the gaining FI 103. As mentioned above, the service layer 605 is stateless and therefore, the services layer 605 instructs the events processing layer 607 to initiate a state machine according to a predefined communication pattern. This state machine information needs to be persistently stored in a transaction table in the persistence layer 606 even in the event of a failure of an entire data centre, such as in case of a natural disaster. Therefore, at this stage, the state machine information is duplicated to a second data centre in sufficient geographical distance from the first data centre. The same storage requirement applies for changes to the association of the user identifier to a FI. The further processing of the request needs to wait for the completion of the storing at the second data centre.

Once the state machine is initiated and made durable the services layer 605 can query the state machine for the next step. In this case, the next step is to create a request for authorisation. This request passes the application switching layer 602, the mediation layer 604 and the integration layer 601 and is sent 122 to the original FI 102. This starts a timer to detect a time out of the response of the original FI 102. After technical validation by the original FI, the integration layer 601 receives a response message acknowledging the correct transmittal of the request for authorisation. This acknowledgement is passed to the mediation layer 604 to further monitor the responsiveness of the original FI.

Once the original FI generates an authorisation and sends it to the CFMS 104, the authorisation is received by the integration layer 601 and passes through the mediation layer 604 and the application switching layer 602 to the services layer 605. Receiving the authorisation prompts the services layer 605 to advance the state machine in the event processing layer 607 to the next state. As mentioned previously, the state of the state machine needs to be persistent and therefore, the duplication of the state change to a second data centre is again necessary.

After this step of advancing the state machine, the services layer 605 interacts with the persistence layer 606 to associate the user identifier to the gaining FI 103. Then, the service layer generates confirmation messages for the gaining FI 603 and the original FI 602. These messages pass through the application switching layer 602, the mediation layer 604 and the integration layer 601. The confirmation messages are then sent to the gaining FI 603 and the original FI 602.

If the original FI 102 in order to create the authorisation, sends an authorisation code to the user 101, then the receiving 125 and sending 126 of the authorisation code by the CFMS 104 follows similar scheme as the three party scheme described above.

FIG. 7 illustrates a state transition diagram 700 for the state machine stored in the persistence layer. Porting requests, authorisation requests and authorisation confirmations are associated with a specific porting transaction via the transaction identifier as described above. In turn, each porting transaction is associated with one state machine. As a result, when receiving a message related to a specific transaction the service layer can access the state machine and the current state stored in the persistence layer 706 for that transaction.

The state transition diagram 700 comprises four states, waiting for port request 702, waiting for authorisation request 704, waiting for authorisation confirmation 706 and settlement 708.

After initialisation the current state of the state machine is wait for port request 702. In a different example, the state machine is not initialised before a port request is received. As a result, the state of wait for port request is not required in that example.

The communication and mediation layer as described above receives an input message from a sender, validates the input message and sends the input message to the service layer 405. Examples of validation are described above.

In a first case the input message is a port request. In this case the service layer 605 determines a user identifier, a gaining FI 103 and porting information based on the input message. With this information the original FI 102 is determined by the service layer 605 by looking up the original FI 102 in the persistence layer 606 in FIG. 6. The service layer 605 also creates an output message that includes the port request and sets as the recipient the original FI 102. This output message including the port request causes the original FI 102 to send to the user 101 an authorisation code that is associated with the porting. The service layer 605 sends the output message to the communication and mediation layer and creates a state machine associated with the transaction identifier from the message. The predetermined state transition logic present in the state machine causes the current state stored in the persistence layer 606 to be advanced 712 to waiting for authorisation request 704.

In a second case the input message is an authorisation request and includes the authorisation code as provided by the user to the gaining FI 103 and the current state of the state machine associated with the transaction identifier from the message is waiting for authorisation request 704. In this case the service layer 605 determines the original FI 102 (such as by performing the look up based on the transaction identifier or the user identifier in the persistence layer 605, or extracting the original FI identifier as incorporated in the received input message). The service layer 605 then creates an output message having the original FI 102 as recipient. This output message including the authorisation request causes the original FI 102 to verify the authorisation code. The service layer 605 then sends the output message to the communication and mediation layer. The predetermined state transition logic present in the state machine causes the current state stored in the persistence layer 606 to be advanced 714 to waiting for authorisation confirmation 706.

In a third case the input message is an authorisation confirmation and the current state of the state machine associated with the transaction identifier from the message is waiting for authorisation confirmation 706. In this case the service layer 605 determines the gaining FI 103 (again by lookup or by extracting it from the input message) and creates an output message having the gaining FI 103 as recipient. This output message includes the authorisation confirmation and provides confirmation to the gaining FI 103 that the payment has been authorised. The service layer 605 then sends the output message to the communication and mediation layer. The predetermined state transition logic present in the state machine causes the current state stored in the persistence layer 606 to be advanced 716 to porting 708.

FIG. 8 illustrates data 800 on a data store comprising a document table 810, an access control table 820, a user data table 830 and a transaction data table 840. The tables are accessed by different layer from FIG. 6. For example, the document table 810 and access control table 820 are accessed by the document processing layer 608 while the transaction data table 840 is accessed by the event processing layer 607.

The document table 810 stores data related to documents registered with the CFMS 105. Each entry in the document table 810 stores the association between the document identifier, the document reference and the document metadata. When in use, the CFMS 105 accesses the document table 810 to store a new entry when a new document is registered. The CFMS 105 retrieves the document data and in particular the document reference when the document is requested. In this example, three document are registered, that is an invoice 811, a remittance advice 812 and a prospectus 813.

The access control table 820 stores information about which user has certain rights to certain documents. It is noted that one document identifier can have multiple entries in the access control table 820. In this example, a first user 831 has permission to view and delete document 811 while a second user 832 has permission to only view document 811. Typically, if document 811 is an invoice user 831 is the payee who has sent the invoice to user 832 who is the payer. The payee 831 can view and delete the invoice while the payer 832 can only view the invoice. Similarly, if the document 812 is a remittance advice, a payer can view and delete the remittance advice while the payee can only view the remittance advice. In contrast, the prospectus 813 may be sent to many different users and therefore the access control table stores many entries to grant permission to view the prospectus to many users.

Every time a document is attached to a transaction from a sender to a receiver, the CFMS 105 checks whether an entry already exists in the access control table and if not creates a new entry allowing the sender to view and delete the document and the receiver to view the document.

The user data table 830 stores an association of the user identifier with an FI. In this example, user 831 has an account with bank X while users 832 and 833 have their accounts with bank Y. When a new user registers with the CFMS 105, the CFMS 105 creates a new entry in the user data table. When a sender sends any transaction to that user identifier as receiver, the CFMS 105 queries the user data table 830 to determine the FI of the receiver and sends the transaction to the receiver's FI.

In case the CFMS 104 receives a message including a port request from a gaining FI, the CFMS 104 looks up the original FI 102 from user data table 830. This is necessary since the port request needs to be sent to the original FI 102 although the user 101 initiates the port request from the gaining FI 103. Once the CFMS 104 receives the authorisation confirmation, the CFMS 104 changes the FI in the user data table 830 to the gaining FI 103.

The transaction data table 840 stores data related to transactions which are currently pending. In this example, transaction 842 is a port and the CFMS 105 is waiting for a authorisation request including the authorisation code from the gaining FI 103. The CFMS 105 creates a new entry when the state machine is created. When the transaction is finished, such as by changing data in the user data table 830, the entry in the transaction table 840 is deleted.

It will be appreciated by persons skilled in the art that numerous variations and/or modifications may be made to the invention as shown in the specific embodiments without departing from the scope of the invention as broadly described.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer storage is readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local or wide area network or a publicly accessible network such as the internet.

It should also be understood that, unless specifically stated otherwise as apparent from the following discussion, it is appreciated that throughout the description, discussions utilizing terms such as “receiving”, “sending”, “processing” or “computing” or “calculating”, “optimizing” or “estimating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

What is claimed is:

1. A computer implemented method for associating a user identifier with a gaining financial institution (FI), wherein the user identifier is associated with an original FI, the method comprising:
(a) receiving from the gaining FI a request to associate the user identifier with the gaining FI;
(b) sending to the original FI the request;
(c) receiving from the original FI a confirmation of the request; and
(d) storing in computer storage a change in the association of the user identifier from the original FI to the gaining FI.

2. The method according to claim 1, wherein the method comprises the further step of sending to the gaining FI confirmation of the association of the user identifier with the gaining FI.

3. The method according to claim 1, wherein the method further comprises the step of determining the original FI that the request should be sent to based on the user identifier as included in the request.

4. The method according to claim 1, wherein step (a) comprises receiving a verification code or identifying information, and validating the request based on the verification code and/or the identifying information.

5. The method according to claim 1, wherein after step (b) the method further comprises the steps of:
receiving from the gaining FI an authorisation code; and
sending the authorisation code to the original FI.

6. The method according to claim 1, wherein step (a) of the method comprises receiving attributes associated with the user identifier.

7. The method according to claim 1, wherein after at least step (b), the method further comprises the steps of:
receiving first data associated with the user identifier from the original FI; and
sending second data based on the first data to the gaining FI.

8. The method according to claim 7, wherein the first data associated with the user identifier includes a transaction history and/or an address book.

9. A non-transitory computer readable medium with an executable program stored thereon that when executed causes a computer to perform the method according to claim 1.

10. A computer system for associating a user identifier with a gaining FI, wherein the user identifier is associated with an original FI, the system comprising:
computer storage to store an association of the user identifier with the original FI;
one or more communications ports; and
one or more processors to operate the communications port to receive from the gaining FI a request to associate the user identifier with the gaining FI, send to the original FI the request and receive from the original FI a confirmation of the request, and cause a change in the association of the user identifier from the original FI to the gaining FI to be stored in computer storage.

11. A computer implemented method for disassociating a user identifier from an original FI, the method comprising:
(a) receiving a request for confirmation to disassociate the user identifier from the original financial institution;
(b) determining authorisation to disassociate the user identifier from the original FI; and
(c) sending confirmation to disassociate the user identifier.

12. The method of claim 11, wherein step (a) is received from a portal or a CFMS.

13. The method of claim 11, wherein the method further comprises the step of storing in computer storage a change in the disassociation of the user identifier from the original FI.

14. The method of claim 11, wherein step (b) further comprises:
sending to the user associated with the user identified a first authorisation code;
receiving from a CMFS a second authorisation code;
determining whether the first and second authorisation code matches and if so, only then performing step (c).

15. The method of claim 11, wherein step (b) further comprises:
determining whether there is approval for the request stored in computer storage, and if so, only then performing step (c).

16. The method of claim 11, wherein the method further comprises sending financial information associated with the user identifier.

17. A non-transitory computer readable medium with an executable program stored thereon that when executed causes a computer to perform the method according to claim 11.

18. A computer system for disassociating a user identifier from an original FI, the system comprising:
one or more communications ports; and
one or more processors to operate the communications port to receive a request for confirmation to disassociate the user identifier from the original financial institution, to determine authorisation to disassociate the user identifier from the original FI, and to operate the communications port to send confirmation to disassociate the user identifier.

19. A computer system for controlling the process of associating a user identifier with a gaining financial institution (FI), the computer system comprising:
a persistence layer to store a status for the payment and user data including a user identifier and associated original financial institution (FI);
a communication and mediation layer to receive an output message from a service layer, to send the output message to a recipient, to receive an input message from a sender, to validate the input message and to send the input message to the service layer; and
the service layer
to receive the input message from the communication and mediation layer,
where the input message includes a port request to associate the user identifier with a gaining FI, to determine a user identifier based on the payment request, to determine an original FI based on the user identifier and the user data in the persistence layer, to create the output message having the original FI as recipient and including the port request, that causes the original FI to send to the user an authorisation code that is associated with the port request, to send the output message to the communication and mediation layer and to set the status in the persistence layer to waiting for authorisation request,
where the status is waiting for authorisation request and the input message includes an authorisation request associated with the port request and having the authorisation code as provided by the user to the gaining FI, to determine the original FI, to create the output message having the original FI as recipient and including the authorisation request, that causes the original FI to verify the authorisation code, to send the output message to the communication and mediation layer and to set the status in the persistence layer to waiting for authorisation confirmation, and
where the status is waiting for authorisation confirmation and the input message includes an authorisation confirmation, to determine the gaining FI, to create the output message having the gaining FI as recipient and including the authorisation confirmation, to send the output message to the communication and mediation layer, and to store in computer storage a change in the association of the user identifier from the original FI to the gaining FI.
